(19) United States
(12) Patent Application Publication
(10) Pub. No.: US 2004/0111475 A1
(43) Pub. Date: Jun. 10, 2004

(54) Method and apparatus for selectively identifying misspelled character strings in electronic communications

(75) Inventor: Dale M. Schultz, Chelmsford, MA (US)

Correspondence Address: KUDIRKA & JOBSE, LLP, ONE STATE STREET, SUITE 800, BOSTON, MA, 02109, US

(73) Assignee: International Business Machines Corporation, Armonk, NY (US)

(21) Appl. No.: 10/313,478

(22) Filed: Dec. 6, 2002

(51) Int. Cl. G06F 15/16; G09G 5/00

(52) U.S. Cl. 709/206; 345/744

(57) ABSTRACT

A technique for avoiding false alarms generated by a spell checking function associated with electronic messaging applications are disclosed and may be used separately or in combination. According to a first technique, at the start of the spell checking operation, all the text in the recipient and/or carbon copy (CC) and blind carbon copy (BC) fields of a message is parsed to form a word list, the number and content of the entries in the word list being a function of the recipient address format and the parser functionality. The word list is then passed to the spell checker as if the words contained therein were part of a ‘user’ dictionary or word exception list, i.e. a list of words that are to be regarded as correct. The spell check operation is then performed as usual with the spell checker comparing an examined word to the word list, and, if a match occurs, the examined word is assumed to be a spelled correctly and ignored by the spell checker, without any alert to the user. According to a second technique, the spell checker processes the message as usual and when an unrecognized word or character string is found, the spell checker software then checks to see if that word or character string is contained anywhere within the recipient, and/or CC and BC fields and sender fields of the message. If the word or character string in question is also found within the recipient or CC/BC fields, the word is ignored by the spell checker without any alert to the user. The two techniques may be combined, with the first technique used when the message size is above a threshold and likely to have more misspelled words, while second technique may be used if the message size is below the threshold or if the list of recipient addresses is long.

### FIELD OF THE INVENTION

This invention relates, generally, to data processing systems and, more specifically, to a technique for efficiently processing electronic mail documents for spelling errors.

### BACKGROUND OF THE INVENTION

Electronic mail has become one of the most widely used business productivity applications. Electronic mail applications often include functionality to identify spelling errors in text, referred to hereafter simply as spell checking. For example, Lotus Notes, commercially available from International Business Machines Corporation, Armonk, N.Y., includes a facility for performing spell checking of composed messages. The same is true for Outlook, commercially available from Microsoft Corporation, Redmond Wash. It is common for electronic mail software to perform a spell check on the text of a composed message that is to be sent. Such text often contains:

names of people who are direct or indirect recipients of the mail

product names associated with the recipients

company names associated with the recipients

the name of the sender

the company of the sender

Because these items often contain first names and surnames from many different cultures, invented words such as company names and product names, various forms of acronyms and abbreviations, the spell checking functionality of the email application or a separate application, flags as possible errors many items that are spelled correctly but which are not familiar to the spell checking function. This typically occurs because the dictionary of known words with which the spell checking function operates does not include these words or character strings. As a result, it is often frustrating and inefficient to have a spell checker stop and flag, as a possible error all people, product and company names and other items that are mentioned in the message text, even if the character string already exists in one of the recipient addresses.

Some spell check applications allow the user to add words to the user's dictionary of known words associated with the spell checking function the first time the word is encountered, however, this process is tedious and time consuming. Other applications include a rudimentary ignore function. For example, there is currently spell checking functionality built into Lotus Notes which has an ignore option. If a character string is flagged as potentially misspelled, i.e., it is not contained within the master dictionary associated with application or the user dictionary associated with the user, the user can ignore the highlighted character string for the remainder of the spell check session by selecting the option accordingly. The spell checking functionality, however, does not process any address character strings within the recipient, CC or BC fields of an electronic mail message.

Accordingly, a need exists for a way to dynamically prevent the spell checking function associated with an electronic messaging application from flagging, as a possible error, all people, product and company names and other items that are mentioned in the message text.

A further need exists for a way to enable the spell checking function associated with an electronic mail application to process and identify those words in a message which are already contained within the recipient addresses of the message.

Yet a further need exists for an electronic mail application that efficiently processes all people, product and company names and other items that are mentioned in the message text, with less false alarms.

### SUMMARY OF THE INVENTION

The present invention discloses techniques for avoiding false alarms generated by a spell checking function associated with an electronic mail application. These techniques may be used separately or in combination to achieve the purpose of the invention. According to the first technique, at the start of the spell checking operation, all the text in the recipient and/or carbon copy (CC) and blind carbon copy (BC) fields of a message is parsed to form a word list, the number and content of the entries in the word list being a function of the recipient address format and the parser functionality. The word list is then passed to the spell checker as if the words contained therein were part of a ‘user’ dictionary or word exception list, i.e. a list of words that are to be regarded as correct. The spell check operation is then performed as usual with the spell checker comparing an examined word to the word list, and, if a match occurs, the examined word is assumed to be a spelled correctly and ignored by the spell checker, without any alert to the user.

According to the second technique, the spell checker processes the message as usual and when an unrecognized word or character string is found, the spell checker software then checks to see if that word or character string is contained anywhere within the recipient, and/or CC and BC fields and sender fields of the message. If the word or character string in question is also found within the recipient or CC/BC fields, the word is ignored by the spell checker without any alert to the user. If the word in question is not contained in these fields, then the word is flagged and presented for possible correction. This second technique has the advantage that the recipient fields are only inspected if required.

In one implementation, the two techniques may be combined, with the first technique used when the message size is above a threshold and likely to have more misspelled words, while second technique may be used if the message size is below the threshold or if the list of recipient addresses is long. It is further contemplated that the techniques of the present invention may be switched on or off, as desired, by the user in a fashion similar to other spell check options such as ignoring words that contain numbers, all uppercase, etc.

According to a first aspect of the present invention, in a computer system capable of executing a process for sending messages to an address associated with the message and for executing a spell checking process for analyzing character strings within the message, a method comprises: (A) parsing an address field associated with the message; (B) storing in memory a character string located within the address field; and (C) comparing a second character string from the message with at least a portion of the character string stored in memory. In one embodiment the method further comprises ignoring the second character string, if the second character string matches at least a portion of the character string stored in memory.

According to a second aspect of the present invention, a computer program product and computer data signal for use with a computer system capable of executing a process for sending messages to an address associated with the message and for executing a spell checking process for analyzing character strings within the message, comprises: (A) program code for parsing an address field associated with the message; (B) program code for storing in memory a character string located within the address field; and (C) program code for comparing a second character string from the message with at least a portion of the character string stored in memory.

According to a third aspect of the present invention, an apparatus for use with a computer system capable of executing a process for sending messages to an address associated with the message and for executing a spell checking process for analyzing character strings within the message, the apparatus comprises: (A) program logic for parsing an address field associated with the message; (B) program logic for storing in memory a character string located within the address field; and (C) program logic for comparing a second character string from the message with at least a portion of the character string stored in memory.

According to a fourth aspect of the present invention, in a computer system capable of executing a communication process for sending messages to an address associated with the message and for executing a spell checking process for analyzing character strings within the message, a method comprises: (A) storing in a buffer memory a character string from a portion of the message other than an address field associated with the message; and (B) comparing the character string in the buffer memory with at least a portion of a character string in the address field associated with the message. In one embodiment the method further comprises ignoring the character string in the buffer memory, if the character string in the buffer memory matches at least a portion of the character string in the address field.

According to a fifth aspect of the present invention, a computer program product for use with a computer system capable of executing a communication process for sending messages to an address associated with the message and for executing a spell checking process for analyzing character strings within the message, the computer program product comprising a computer useable medium having embodied therein program code comprising: (A) program code for storing in a buffer memory a character string from a portion of the message other than an address field associated with the message; and (B) program code for comparing the character string in the buffer memory a with at least a portion of a character string in the address field associated with the message.

### BRIEF DESCRIPTION OF THE DRAWINGS

The above and further advantages of the invention may be better understood by referring to the following description in conjunction with the accompanying drawings in which:

FIG. 1 is a block diagram of a computer systems suitable for use with the present invention;

FIG. 2 is a conceptual block diagram illustrating of the relationship between the components of the system in which the present invention may be utilized;

FIG. 3 is a conceptual illustration of a computer network environment in which the present invention may be utilized;

FIG. 4 is a conceptual block diagram illustrating of the relationship between the components of the present invention;

FIG. 5 is a flow chart illustrating the process steps performed in accordance with the first technique of the present invention; and

FIG. 6 is a flow chart illustrating the process steps performed in accordance with the second technique by the present invention.

### DETAILED DESCRIPTION

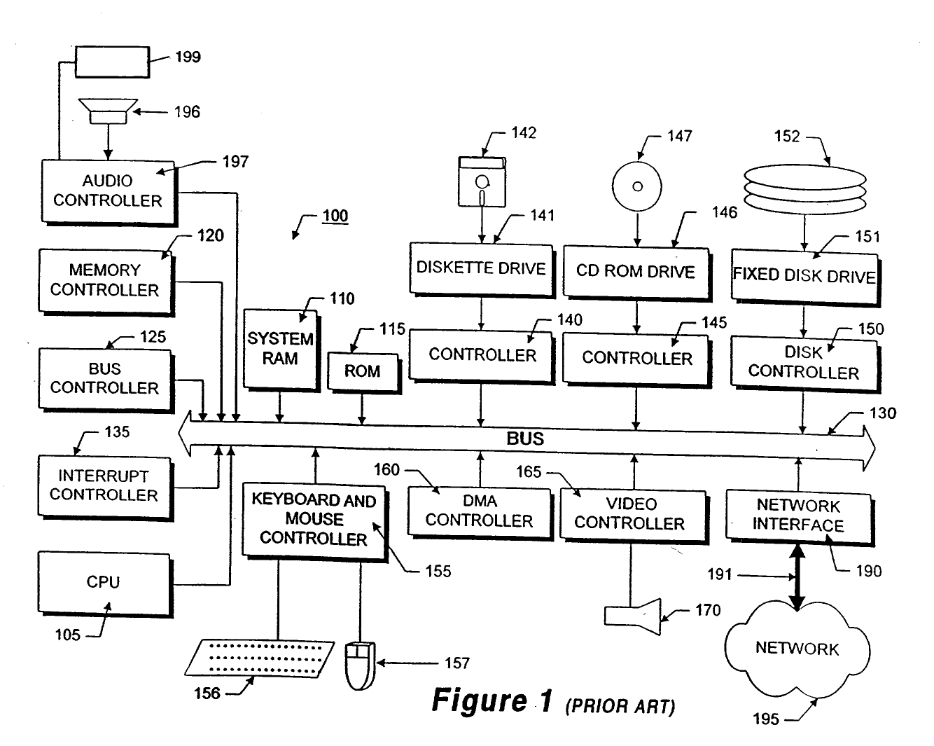

FIG. 1 illustrates the system architecture for a computer system 100, such as a Dell Dimension 8200, commercially available from Dell Computer, Dallas Tex., on which the invention can be implemented. The exemplary computer system of FIG. 1 is for descriptive purposes only. Although the description below may refer to terms commonly used in describing particular computer systems, such as an IBM Think Pad computer, the description and concepts equally apply to other systems, including systems having architectures dissimilar to FIG. 1.

The computer system 100 includes a central processing unit (CPU) 105, which may include a conventional microprocessor, a random access memory (RAM) 110 for temporary storage of information, and a read only memory (ROM) 115 for permanent storage of information. A memory controller 120 is provided for controlling system RAM 110. A bus controller 125 is provided for controlling bus 130, and an interrupt controller 135 is used for receiving and processing various interrupt signals from the other system components. Mass storage may be provided by diskette 142, CD ROM 147 or hard drive 152. Data and software may be exchanged with computer system 100 via removable media such as diskette 142 and CD ROM 147. Diskette 142 is insertable into diskette drive 141 which is, in turn, connected to bus 130 by a controller 140. Similarly, CD ROM 147 is insertable into CD ROM drive 146, which is connected to bus 130 by controller 145. Hard disk 152 is part of a fixed disk drive 151, which is connected to bus 130 by controller 150.

User input to computer system 100 may be provided by a number of devices. For example, a keyboard 156 and mouse 157 are connected to bus 130 by controller 155. An audio transducer 196, which may act as both a microphone and a speaker, is connected to bus 130 by audio controller 197, as illustrated. It will be obvious to those reasonably skilled in the art that other input devices such as a pen and/or tablet and a microphone for voice input may be connected to computer system 100 through bus 130 and an appropriate controller/software. DMA controller 160 is provided for performing direct memory access to system RAM 110. A visual display is generated by video controller 165 which controls video display 170. In the illustrative embodiment, the user interface of a computer system may comprise a video display and any accompanying graphic use interface presented thereon by an application or the operating system, in addition to or in combination with any keyboard, pointing device, joystick, voice recognition system, speakers, microphone or any other mechanism through which the user may interact with the computer system. Computer system 100 also includes a communications adapter 190, which allows the system to be interconnected to a local area network (LAN) or a wide area network (WAN), schematically illustrated by bus 191 and network 195.

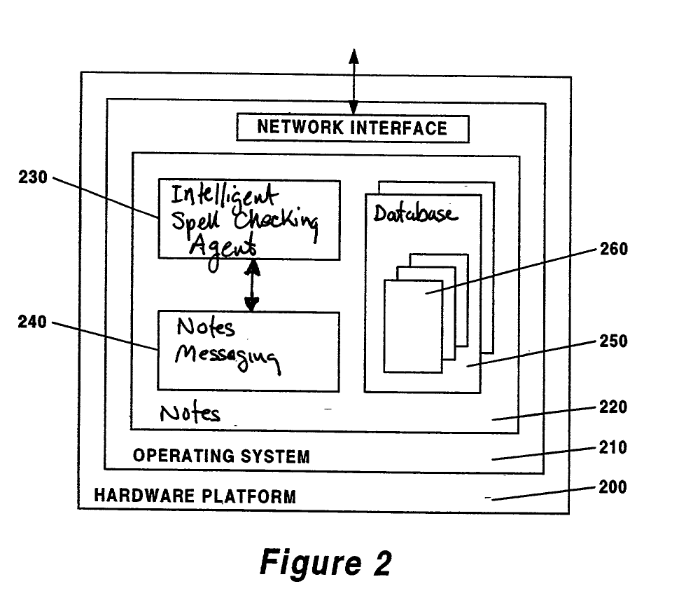

Computer system 100 is generally controlled and coordinated by operating system software, such as the WINDOWS NT, WINDOWS XP or WINDOWS 2000 operating system, commercially available from Microsoft V Corporation, Redmond Wash. The operating system controls allocation of system resources and performs tasks such as process scheduling, memory management, and networking and I/O services, among other things. In particular, an operating system resident in system memory and running on CPU 105 coordinates the operation of the other elements of computer system 100. The present invention may be implemented with any number of commercially available operating systems including OS/2, AIX, UNIX and LINUX, DOS, etc. The relationship among hardware 200, operating system 210, and user application(s) 220 is shown in FIG. 2. One or more applications 220 such as Lotus Notes or Lotus Sametime, both commercially available from International Business Machines Corporation, Armonk, N.Y., may execute under control of the operating system 210. If operating system 210 is a true multitasking operating system, multiple applications may execute simultaneously.

In the illustrative embodiment, the present invention may be implemented using object-oriented technology and an operating system which supports execution of object-oriented programs. For example, the inventive code module may be implemented using the C++ language or as well as other object-oriented standards, including the COM specification and OLE 2.0 specification for Microsoft Corporation, Redmond, Wash., or, the Java programming environment from Sun Microsystems, Redwood, Calif.

In the illustrative embodiment, the elements of the system are implemented in the C++ programming language using object-oriented programming techniques. C++ is a compiled language, that is, programs are written in a human-readable script and this script is then provided to another program called a compiler which generates a machine-readable numeric code that can be loaded into, and directly executed by, a computer. As described below, the C++ language has certain characteristics which allow a software developer to easily use programs written by others while still providing a great deal of control over the reuse of programs to prevent their destruction or improper use. The C++ language is well known and many articles and texts are available which describe the language in detail. In addition, C++ compilers are commercially available from several vendors including Borland International, Inc. and Microsoft Corporation. Accordingly, for reasons of clarity, the details of the C++ language and the operation of the C++ compiler will not be discussed further in detail herein.

As will be understood by those skilled in the art, Object-Oriented Programming (OOP) techniques involve the definition, creation, use and destruction of “objects”. These objects are software entities comprising data elements, or attributes, and methods, or functions, which manipulate the data elements. The attributes and related methods are treated by the software as an entity and can be created, used and deleted as if they were a single item. Together, the attributes and methods enable objects to model virtually any real-world entity in terms of its characteristics, which can be represented by the data elements, and its behavior, which can be represented by its data manipulation functions. Objects are defined by creating “classes” which are not objects themselves, but which act as templates that instruct the compiler how to construct the actual object. A class may, for example, specify the number and type of data-variables and the steps involved in the methods which manipulate the data. When an object-oriented program is compiled, the class code is compiled into the program, but no objects exist. Therefore, none of the variables or data structures in the compiled program exist or have any memory allotted to them. An object is actually created by the program at runtime by means of a special function called a constructor which uses the corresponding class definition and additional information, such as arguments provided during object creation, to construct the object. Likewise objects are destroyed by a special function called a destructor. Objects may be used by using their data and invoking their functions. When an object is created at runtime memory is allotted and data structures are created.

Network Environment

FIG. 2 illustrates the local system environment in which the present invention may be practiced. The illustrative embodiment of the invention may be implemented as part of Lotus Notes® and a Lotus Domino server, both commercially available from International Business Machines Corporation, Armonk, N.Y., however, it will be understood by those reasonably skilled in the arts that the inventive functionality may be integrated into other applications as well as the computer operating system.

To implement the primary functionality of the present invention in a Lotus Notes environment, an intelligent spell checking agent module, referred to hereafter simply as “agent 230” interacts with the existing functionality, routines or commands of Lotus Notes client application and/or a Lotus “Domino” server, many of which are publicly available. The Lotus Notes client application 220, executes under the control of operating system 210, which in turn executes within the hardware parameters of hardware platform 200. Hardware platform 200 may be similar to that described with reference to FIG. 1. Agent 230 interacts with application 220, particularly the Notes messaging module 240 and with one or more documents 260 in databases 250. The functionality of Agent 230 and its interaction with application 220, particularly Notes messaging module 240 is described hereafter. In the illustrative embodiment, agent 230 may be implemented in an object-oriented programming language such as C++. Accordingly, the data structures and functionality of agent 230 may be implemented with objects displayable by application 220 and may be objects or groups of objects.

The Notes architecture is built on the premise of databases and replication thereof. A Notes database, referred to hereafter as simply a “database”, acts as a container in which data Notes and design Notes may be grouped. Data Notes typically comprises user defined documents and data. Design Notes typically comprise application elements such as code or logic that make applications function. Replicas of databases may be located remotely over a wide area network, which may include as a portion thereof one or more local area networks. In the illustrative every object within a Notes database, is identifiable with a unique identifier, referred to hereinafter as “Note ID”, as explained hereinafter in greater detail.

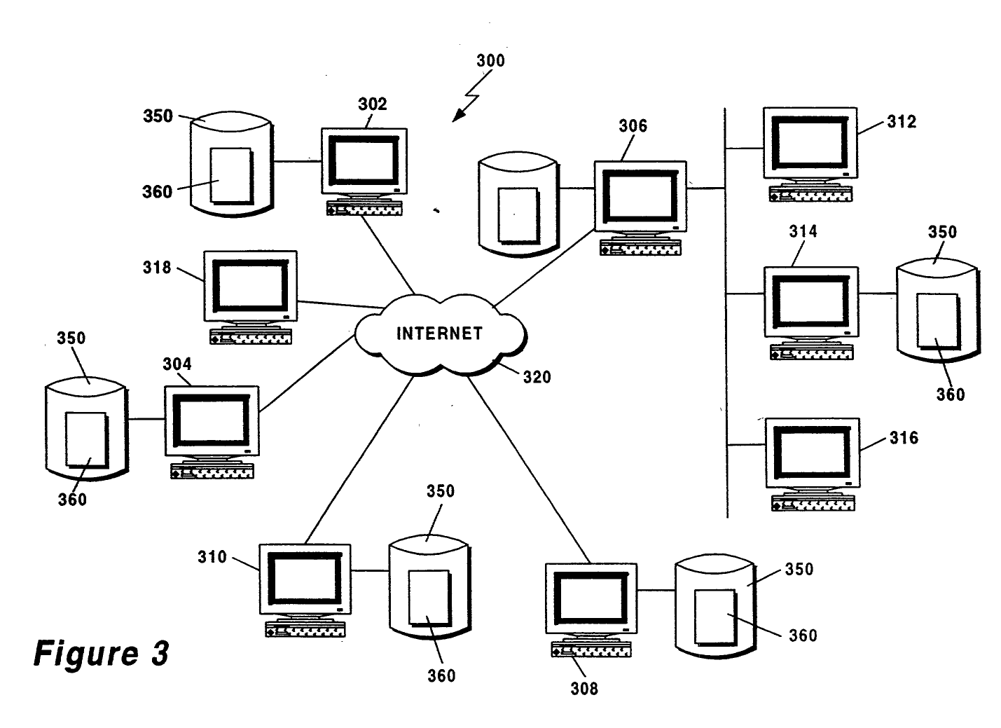

FIG. 3 illustrates a network environment in which the invention may be practiced, such environment being for exemplary purposes only and not to be considered limiting. Specifically, a packet-switched data network 300 comprises servers 302-310, a plurality of Notes processes 310-316 and a global network topology 320, illustrated conceptually as a cloud. One or more of the elements coupled to global network topology 320 may be connected directly or through Internet service providers, such as America On Line, Microsoft Network, Compuserve, etc. As illustrated, one or more Notes process platforms may be located on a Local Area Network coupled to the Wide Area Network through one of the servers.

Servers 302-308 may be implemented as part of an all software application, which executes on a computer architecture similar to that described with reference to FIG. 1. Any of the servers may interface with global network 320 over a dedicated connection, such as a T1, T2, or T3 connection. The Notes client processes 312, 314, 316 and 318, which include mail functionality, may likewise be implemented as part of an all software application that runs on a computer system similar to that described with reference to FIG. 1, or other architecture whether implemented as a personal computer or other data processing system. As illustrated conceptually in FIG. 3, servers 302-310 and Notes client process 314 may include in memory a copy of database 350, which contains document 360.

Intelligent Spell Checking Agent

A basic premise of the invention is to have the spell check function of an electronic mail or instant message application ignore character strings that are present in the recipient address, carbon copy address and blind carbon copy and sender address field(s). Although the concepts of the present invention may be equally applied to any electronic mail or instant message application, the illustrative embodiment will be described with reference to a Lotus Notes environment described herein.

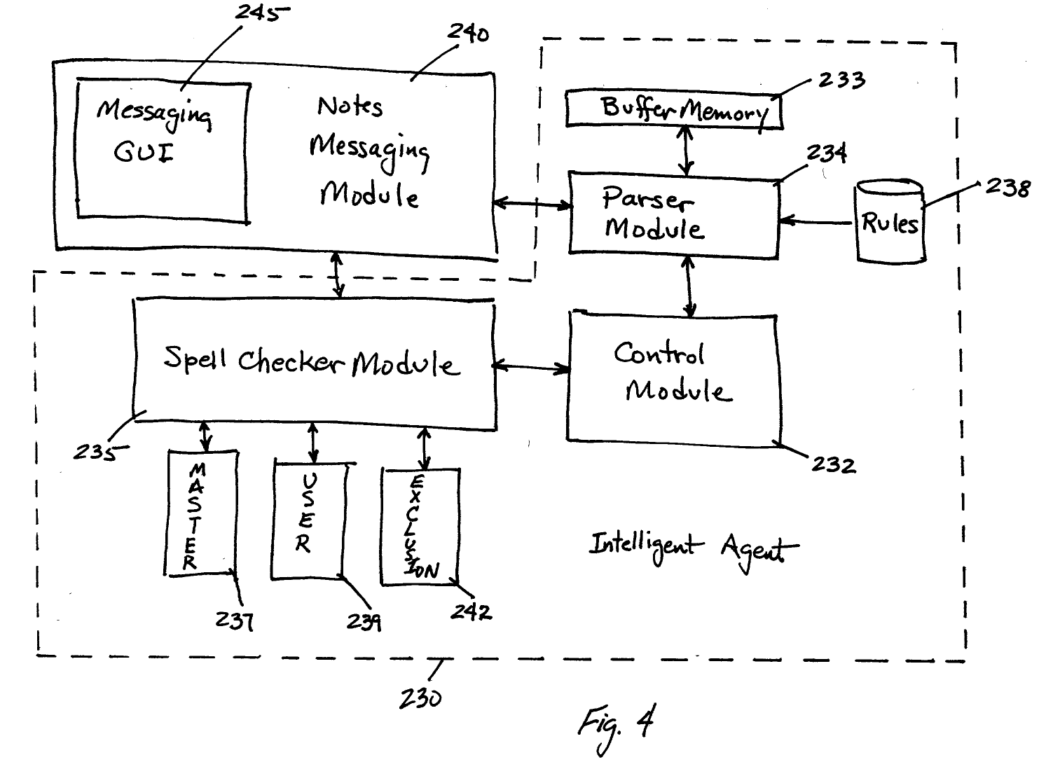

FIG. 4 illustrates conceptually the relationship between agent 230 and the other Notes application 220 with which agent 230 operates. The Notes application 220 includes a Notes messaging module 240. Included within the Notes messaging module 240 is a Messaging GUI module 245 and a spell checker 235. Messaging GUI module 245 is responsible for rendering the visual display of a message, including any content and relevant fields. Messaging GUI module 245 interacts with the Notes application and the operating system 210 in order to achieve the proper windowing and rendering of graphic data using techniques known in the relevant arts.

Spell checker 235 interacts with Notes messaging module 240 and Messaging GUI module 245 in the same manner as do current commercially available Notes products. Spell checker 235 comprises a buffer 233, parser module 234, rule database 238 and none, one or more dictionaries, such as master dictionary 237 and user dictionary 239.

The implementation and function of spell checker 235 may be in accordance with conventional spell checker products. In particular, an application, such as Notes 220, specifically the Notes messaging module 240, calls the spell checker 235 through an Application Programming Interface (API) to process text in the form of character strings. The spell checker 235 reads a portion of a character string using parser module 234. Numerous parsing algorithms are known in the art and will not be described herein for the sake of brevity. Utilizing one or more rules within database 238, the parser module 234 delineates between words and/or characters within the character string and stores the first character string in buffer 233. Typically, a space or other character is utilized as a delineator between candidate character strings. The candidate character string in the buffer is compared, to master dictionary 237, which includes a listing of correctly spelled words or character strings for a particular natural language. As used herein, the term “natural language” includes all punctuation, symbols, and numeric characters associated with a particular natural language.

The candidate character string is mapped into the master dictionary 237 in an attempt to locate a matching character string from the master dictionary 237. The number of entries within master dictionary 237 may vary considerably, depending on the sophistication of the spell checker 235. For space considerations, the master dictionary 237 is typically abbreviated or abridged to include only the most common written or spoken terms within a particular natural language, as compiled by the application designer. If a match occurs between the candidate character string and an entry within master dictionary 237, the candidate character string within the buffer is assumed to be spelled correctly and the next candidate character string from buffer 233 is analyzed. Note that the actual arrangement of buffer 233 and interaction of parser module 234 with spell checker 235 may vary. For example, the buffer may contain multiple candidate character string entries so that the parser module 234 may “read ahead” while the spell checker 235 is comparing a candidate character string with master dictionary 237 or user dictionary 239. If no match for the first candidate character string was found within master dictionary 237, the first candidate character string is compared with a user dictionary 239.

The user dictionary 239 is a compilation of character strings and/or words created or compiled by a user-through use of the application. As with the master dictionary 237, if the candidate character string matches an entry within user dictionary 239, the candidate character string is assumed to be spelled correctly and the next candidate character string and/or word is read into or processed from buffer 233. Alternatively, if the candidate character string does not match any of the entries within either master dictionary 237 or user dictionary 239, the spell checker 235 provides a visual and/or audio queue to the user via the graphic user interface, here, the messaging GUI module 245 to alert the viewer/user that a character string and/or word may potentially be misspelled. Visual notification of the character string within the context of a document or message may occur in a number of different ways including bolding, underlining, highlighting or changes to any of the color, font, style, point size, or other graphic manipulation of the character string. Such visual notification may occur alone or in addition to an audio queue. The audio queue may comprise generation of an acoustic event, such as a beep, using the appropriate hardware and an acoustic transducer associated with the hardware platform on which the spellchecker application is executing, or, playback of an audio file by the application.

Spell check applications may vary in sophistication and functionality. For example, some spell check applications associated with word processing applications may, in addition to providing an alarm or notification of a potential misspelled character string, recommend one or more proper spellings, based on the most closely matched entries from either the master dictionary or user dictionary. Still other spell checkers may actually provide a selectable auto-correct function in which misspelled character strings are automatically replaced with one of the entries from either dictionarie 237 or 239 if the contents are substantially similar, e.g. transposed letters.

The rule database 238, in the illustrative embodiment, includes not only the rules for conventional parsing of the appropriate natural language, but also includes rules associated with one or more message address formats as described herein. Control module 232 directs parser module 234, either by a default setting or a user definable parameter, which rules from database 238 should be utilized when reading specific fields within a message, as described hereinafter.

The functionality associated with spell checker 235 and parser module 234 is not limited to character strings comprising ASCII characters, but may include any combination of alpha and numeric characters and may be compliant with the Unicode® Standard published by Unicode, Inc. According to the Unicode Standard, “text” refers to alphanumeric characters as well as punctuation marks, diacritics, mathematical symbols, technical symbols, arrows, etc. The Unicode Standard, Version 2.0, and subsequent versions and revisions thereto, provides the capacity to encode all the characters used for the major written languages of the world including Latin, Greek, Armenian, Hebrew, Arabic, Bengali, Thai, Japanese kana, a unified set of Chinese, Japanese, and Korean ideographs, as well as many other languages. Accordingly, the application of the present invention is not limited by the natural language with which it is intended to interact.

The intelligent spell checking agent 230 of the present invention improves the efficiency of a conventional spell checker with the addition of a control module 232. Control module 232 within agent 230 acts as the central controller for the agent 230, directing function calls to the parser 234, spell checker 235, as well as interacting with the Notes messaging module 240 and Messaging GUI module 245. In the illustrative embodiment of the present invention, the program code and instructions that perform the function of agent 230 may be located within Notes messaging module 240, as illustrated. Alternatively, agent 230 may be located outside the Notes application, if the messaging function, including the spell checking function, is a separate application. Agent 230 comprises an exception list 242, a control module 232, and additional rule sets in database 238 useful for parsing a plurality of network address formats. The primary function of agent 230 is to prevent character string(s) present in the recipient address fields of a message from being treated or presented as possible misspelled words. To that end, agent 230 includes the necessary objects, including data elements and methods for instructing parser 234 when to parse the address field of the composed message, maintaining an exclusion dictionary 242 generated as a result of the parsing operation and for interacting with spell checker 235 and Notes messaging module 240.

In the illustrative embodiment, exclusion list 242 may be implemented similar to master dictionary 237 and user dictionary 239, e.g. a listing of extracted character strings that are acceptable as occurrences in the body of a message. In the simplest implementation, exclusion list 242 may simply be a buffer memory having enough capacity to hold the contents of each electronic mail address field associated with the message, in concatenated or other relation, as described with reference to the second technique of the invention.

Once an electronic mail message has been composed and the spell check option of the executing electronic mail or messaging application has been enabled, control module 232, instructs parser 234 to read and extract all character strings in the recipient and sender address fields associated with the message, e.g. any of the primary recipient address field, carbon copy recipient address field or blind carbon copy recipient address field, as well as the sender address field. The character strings are parsed and extracted in accordance with the reads rules associated with the type of electronic mail address format, as defined in rule database 238. Examples of electronic mail address formats and the resulting substrings generated by parser 234 are presented below.

Internet Type Email Addresses

The electronic mail addresses below are Internet type electronic addresses in conformance with RFC 822, entitled “STANDARD FOR THE FORMAT OF ARPA INTERNET TEXT MESSAGES, dated Aug. 13, 1982, and published by the Internet Engineering Task Force (IETF), and available online at www.ieff.org. Examples of electronic mail addresses and the resulting substrings generated by parser 232 are presented below:

Given Internet type email address: Zasiya_Smithe@xwidget.com Parser 234 would extract strings: Zasiya, Smithe, xwidget, com.

Given Internet type email address: Zasiya.Smithe@xwidget.com Parser 234 would extract strings: Zasiya, Smithe, xwidget, corn

Given Internet type email address: Zasiya_Smithe@xsales.xwidget.com

Parser 234 would extract strings: Zasiya, Smithe, xsales, xwidget, com

Given Internet type email address:

“Zazzy Smithe”<Zasiya_Smithe@xwidget.com>

Parser 234 would extract strings: Zazzy, Zasiya, Smithe, xwidget, com

Given Internet type email address:

Zasiya_Smithe@xwidget.com (HomeOffice)

Parser 234 would extract strings: Zasiya, Smithe, xwidget, com, HomeOffice

Notes Type Mail Addresses

The electronic mail addresses below are electronic mail addresses in conformance with Specification for Lotus Notes published by International Business Machines Corporation, Armonk, N.Y. Examples of electronic mail addresses and the resulting substrings generated by parser 234 are presented below:

Given a Notes type email address: Zasiya Smithe/xsales/xwidget/US Parser 234 would extract strings: Zasiya, Smithe, xsales, xwidget, US

Given a Notes type email address:

Zasiya Smithe/xsales/xwidget/US@ARMONK

Parser 234 would extract strings: Zasiya, Smithe, xsales, xwidget, US, Armonk

Given a Notes type address:

this has become corrupted, I need to send you this again.

X.400 Address

The electronic mail addresses below are electronic mail addresses in conformance with X.400 address specification published by the International Telecommunication Union Examples of X.400 type addresses and the resulting substrings generated by parser 234 are presented below:

Given an X.400 address:

Zäsîÿâ \check{S}mïthe/xsälés/xwìdgët/US

Parser 234 would extract strings: Zäsîÿâ, \check{S}mïthe, xsälés, xwìdgët, US

The examples listed above are for exemplary purposes only. The decision to include or exclude parts of a domain name, comment part, routing information or other component of a formatted address character string is an implementation decision as defined by the rules in rule database 238 to which parser 234 responds, is up to the discretion of the system designer, or, alternatively may be implemented as user definable options. Further inventive concept is applicable to any type of addressing format, providing the parsing function within agent 230 is provided with the appropriate rules from database 238 to support the address format.

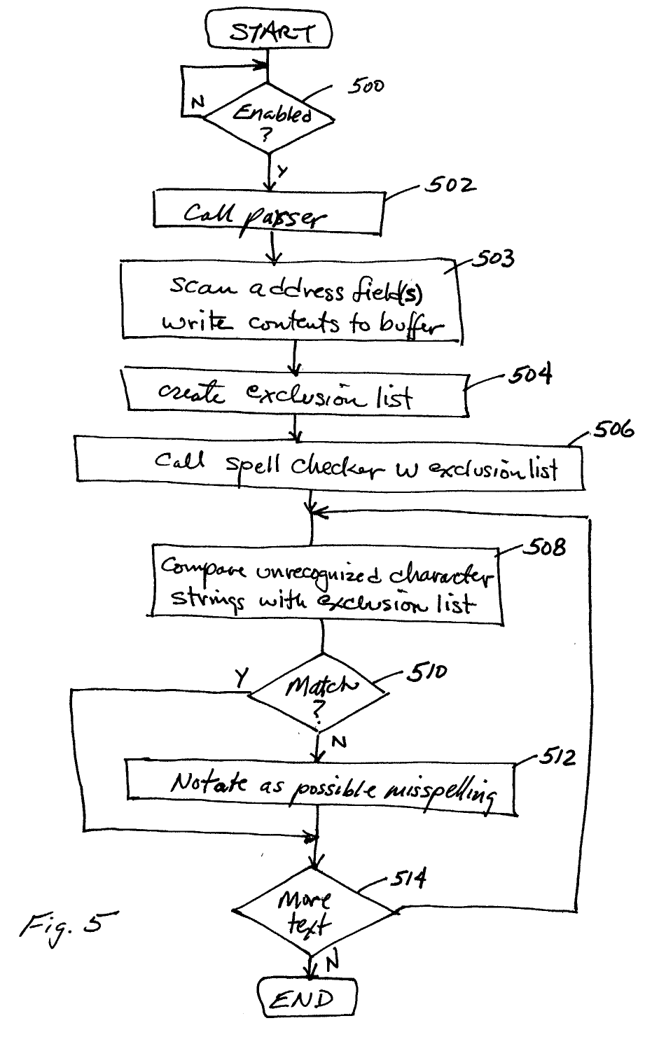

FIG. 5 is a flow chart illustrating the process steps performed by agent 230 in accordance with a first technique of the present invention. For the purposes of illustration, assume that the following exemplary electronic mail message has been composed and that the agent 230 in enabled:

TO: Zasiya_Smithe@xwidget.com

CC: sales@xwidget.com; Yoshitos.Yamamato@cobe.org;

BCC: Louis Gerstners/Armonk/IBM

FROM: Dale_Schultz@getsmart.com

SUBJECT: Quote for 1000 copies of xwidget

Dear Zasiya,

Thank you for your telephone call. I have spoken to Yoshitos Yamamato from the Cobe organisation about getting a box of your xwidget product. When we have it we will show them to Mr Gerstners when we next visit Armonk.

Thanks

Dale Schultz

Managing Director: GetSmart

Enablement of agent 230 may occur through a number of different events including selecting a SEND icon from the electronic mail user interface, selecting or entering a designated spell check command, or upon composition of text if the spell checker has a in real time mode. For purposes of illustration, it is assumed that at least the sender and recipient address fields of a message have been composed and the spell checking function is enabled, as illustrated by decisional step 500. Note that only one of the recipient or sender address fields need be composed in order to obtain the benefits of the invention.

Control module 232 then calls parser module 234 and passes to it a parameter identifying the rule set from rule database 238 to be used while parsing the message address, if known, as illustrated by procedural step 502. The address format may be determined from the value of a default setting, which defines the network address formats supported by the messaging application. In many instances, however, the actual address format within the address fields will be unknown and the parameter may be left blank or provided with a null value. In such instance, parser 234 will scan the first address field, typically the primary recipient address field, write the contents of the address field into buffer 233, as illustrated by step 503. Then, utilizing one or more rules from rule database 238, parser 234 will search for specific symbolic characters such as @, /, <, >, //, +, etc., within the contents of buffer 233. If one or more symbolic characters are recognized, the address format is identified and parser 234 will utilize the appropriate rules from rule database 238 to parse the contents of the address field. For example, in the exemplary electronic mail message, parser 234 would recognize the “@” within the primary recipient address field, indicating that the message format is of the Internet type e-mail address or Notes address format. Parser 234 will then scan the character string contents of the address field, identifying selected delimiting characters, as defined by the rule(s) from rule database 238 for one or both address formats, and generate a list of any candidate character strings found between the selected delimiting characters, as illustrated by procedural step 504. The parser 234 will continue this process for each of the recipient address fields, including the carbon copy address field, the blind carbon copy address field and the sender address field. The candidate address character strings identified by the parser form the exception list 242 and are then passed back to control module 232 as an API argument. Alternatively, the exception list 242 may be stored within memory and the address passed back to control module 232. Note that examples of exception lists 242 for sample addresses for each of the Notes, X.400 and Internet-type messaging formats are described herein. The actual rules used to control parser 234 and the implementation of the parser are within the scope of understanding of those skilled in the arts given the disclosure herein. Given the address as set forth in the exemplary electronic mail message, the exclusion list generated by parser 234 would include the following:

Armonk

Dale

Kobe

Gerstners

Getsmart

IBM

Louis

sales

Shultz

Smithe

Xwidget

Yamato

Yoshitos

Zasiya

.com

.org

Control module 232 then calls the spell checker 235 passing to it either the exclusion list 242 as an argument or the address in memory at which the exclusion list 242 may be found, as illustrated by step 506. Spell checker 235 then begins to process the textual body of the message in a conventional manner, utilizing, in addition to master dictionary 237 and user dictionary 239, the exclusion list 242. Any character string located within the text body of the message and which is not found in either the master dictionary 237 or user dictionary 239 may be considered as an unrecognized character string. The spell checker 235 then attempts to match the unrecognized character string with an entry in exclusion list 242, as illustrated by step 508. If a match occurs, as illustrated by decisional step 510, the unrecognized character string has essentially been “recognized”, deemed spelled properly and, therefore, ignored. If no match for the unrecognized character string is found in any of dictionaries 237 and 239 or list 242, the unrecognized character string is designated as a possible misspelled word or term, as illustrated by procedural step 512, on the graphic user interface of the messaging system. In the illustrative embodiment, the order in which spell checker 235 compares an unrecognized character string against master dictionary 237, user dictionary 239 and exclusion list 242 may be an implementation detail left to the system designer. For example, the exclusion list 242 may, in one embodiment, be the first list accessed by the spell checker 235 in an attempt to identify the unrecognized character string. Alternatively, one or both of the master dictionary 237 and user dictionary 239 may be accessed before exclusion lists 242. In an embodiment, either of the master dictionary 237 or the user dictionary 239 may be eliminated without affecting the functionality of the invention.

Next, spellchecker 235 determines whether additional text exists within the message, typically using parser module 234 in a conventional manner, as illustrated by decisional step 514. If so, the process continues as described previously with respect to steps 508-512, otherwise, the process ends. In alternative embodiments, the Notes messaging module 240 may indicate to control module 232 that any of the address fields or text of the message has been edited, thereby causing the whole process to begin again. Alternatively, in another embodiment in which the spellchecker is enabled to perform in real time, as text is being composed, the spellchecker will compare any newly entered text entered into the input buffer of the messaging application, which may or may not be the same as buffer 233, and as parsed by module 234, against any of dictionaries 237 and 239 and exclusion list 242, in the manner similar to that described herein. Returning to the above exemplary electronic mail message and given the exemplary exclusion list 242, the only character string to be unrecognized in the text body of the message is the term “organisation” which is the British spelling of the word.

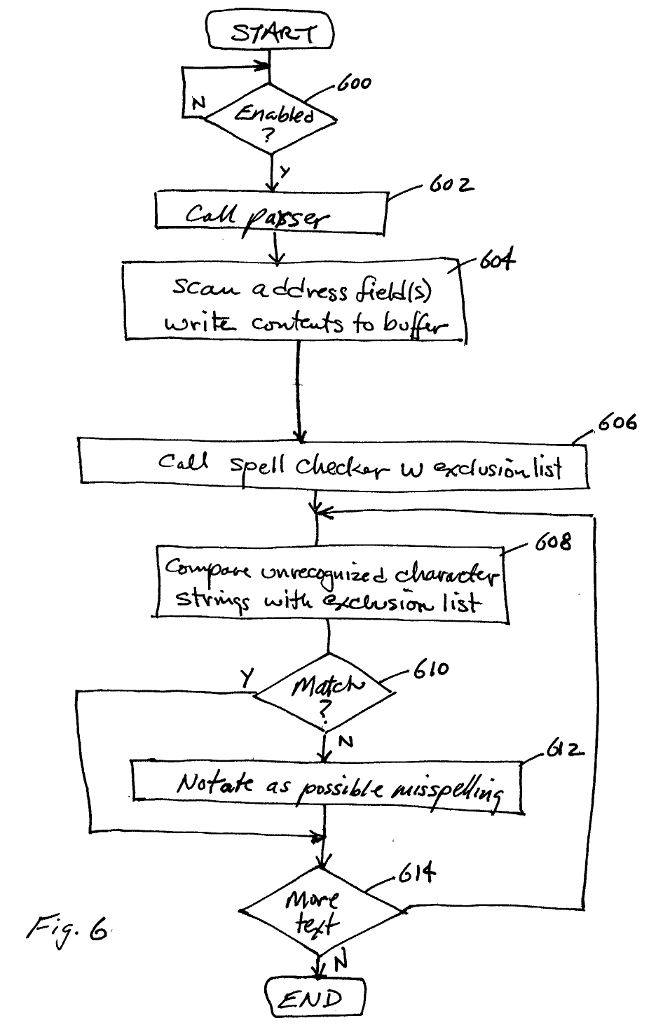

FIG. 6 is a flow chart illustrating the process steps performed in accordance with an alternative embodiment of the present invention. For purposes of illustration, it is assumed that at least the sender and recipient address fields of a message have been composed and the spell checker function is enabled, in a manner as previously described, as illustrated by decisional step 600. Next, parser 234 will scan all the address fields and write all the contents of the address field into buffer 233, as illustrated by procedural step 602. All addresses within the recipient, CC and BC, and, optionally, the sender fields are concatenated in memory or buffer 233 into a single composite character string by parser 234. Alternatively, such concatenation may be performed directly by control module 232, as illustrated by procedural step 606. Note that with this implementation, the parser merely copies the contents of the address fields into buffer 233 without regard for the address format, but does insert a delimiter between the contents from separate fields. For example, given the exemplary electronic mail message, the exclusion list generated by parser 234 in the form of a composite character string in buffer 233 would include the following:

Zasiya_Smithe@xwidget.com;sales@xwidget.com;Yoshitos.Yamamato@cobe.or g;Louis Gerstners/Armonk/IBM;Dale_Schultz@getsmart.com

The composite character string compiled by parser 234 forms the exception list 242, which is then passed back to control module 232 as an API argument. Alternatively, the exception list 242 may remain in buffer 233 or of memory location and the address passed back to control module 232.

Control module 232 then calls the spell checker 235 passing to it either the exclusion list 242 as an argument or the address in memory at which the exclusion list 242 may be found, as illustrated by step 606. Spell checker 235 then begins to process the textual body of the message in a conventional manner utilizing, in addition to master dictionary 237 and user dictionary 239, the exclusion list 242. Any character string located within the text body of the message and which is not found in either the master dictionary 237 or user dictionary 239 may be considered as an unrecognized character string. The spell checker 235 then attempts to match the unrecognized character string with an entry in exclusion list 242. Any unrecognized character strings are passed as an argument to a substring search function within parser 243 which then performs a substring search within buffer 233 to determine if the character string occurs as a substring within the composite string in buffer memory, as illustrated by procedural step 608. If the unrecognized character string is located as a substring in buffer 233, as illustrated by decisional step 610, it will be ignored and spell checker 235 proceeds with the assumption that the substring was spelled correctly. If no match for the unrecognized character string is found in any of dictionaries 237 and 239 or list 242, the unrecognized character string is designated as a possible misspelled word or term, as illustrated by procedural step 612, on the graphic user interface of the messaging system. As with the prior described embodiment, the order in which spell checker 235 compares an unrecognized character string against master dictionary 237, user dictionary 239 and exclusion list 242 may be an implementation detail left to the system designer.

Next, spellchecker 235 determines whether additional text exists within the message, typically using parser module 234 in a conventional manner, as illustrated by decisional step 614. If so, the process continues as described previously with respect to steps 608-612, otherwise the process ends. Returning to the above exemplary electronic mail message and given the exemplary exclusion list 242, the only character string to be unrecognized in the text body of the message is the term “organisation” which is the British spelling of the word. The process described with respect to FIG. 6 may be implemented more simply and is useful when a message has numerous addresses in an address field, e.g. fifty addresses in the CC address field.

The two techniques describe above may be combined for greater efficiency. For example, the first technique, described with reference to FIG. 5, may be used when the message size is above a threshold and likely to have more misspelled words, while second technique, described with reference to FIG. 6, may be used if the message size is below the threshold or if the number of recipient addresses is above a threshold. In this embodiment, the size of the message at the time the spell checker is activated is determined by control module 232. If the size of the message is above a certain threshold, e.g. five hundred characters, then the process described with reference to step 502-514 of FIG. 5, is utilized, otherwise the process described with reference to step 602-614 of FIG. 6, is utilized. It will be obvious to those skilled in the arts that other quantities, such the amount of memory required for a message, may be used to define the threshold. In addition to or in place of the size threshold, if the number of recipient addresses in any one field or all address fields combined is above a threshold, e.g. ten addresses, at the time the spell checker is enabled, as determined by control module 232, then the process described with reference to step 602-614 of FIG. 6, is utilized, otherwise the process described with reference to step 502-514 of FIG. 5, is utilized. With such implementation, the amount of processing required to obtain the benefits of the invention, is managed more efficiently.

Although the illustrative embodiment has been described with reference to a Lotus Notes environment, it will be obvious to those reasonably skilled in the art that other electronic mail applications, such as Groupwise commercially available from Novell Corporation, Provo, Utah, and Microsoft Outlook, commercially available from Microsoft Corporation, Redmond Wash., as well as other communication applications may be suitably substituted to implement the invention. In addition, although the illustrative embodiment has been described with reference to an electronic mail application, it will be obvious to those reasonably skilled in the art that instant messaging utilities and applications, such as AOL Instant Messaging and Lotus Sametime may be used to implement the inventive concepts. Specifically any communication application the is capable of sending text messages to an addressee and which utilizes a spell checker can be used to implement the inventive concepts.

Further, the above concept can be extended to groups wherein the name of a person in a recipient address field is part of a group (list of addresses). In this instance, any other group members' names and addresses will be treated as if they also occurred within the recipient address field, CC or BC fields of the message. In this embodiment, the names and addresses of the other members can be retrieved by control module 232 from Notes messaging module 240 and stored in a temporary memory until parser 234 creates the exclusion list 242 from the additional addresses. Parser 234 can be programmed via rule database 238 to recognizes the format of the group name and pass the same to either control module 232 or from Notes messaging module 240 for retrieval of the complete group address list.

A software implementation of the above-described embodiments may comprise a series of computer instructions either fixed on a tangible medium, such as a computer readable media, e.g. diskette 142, CD-ROM 147, ROM 115, or fixed disk 152 of FIG. 1A, or transmittable to a computer system, via a modem or other interface device, such as communications adapter 190 connected to the network 195 over a medium 191. Medium 191 can be either a tangible medium, including but not limited to optical or analog communications lines, or may be implemented with wireless techniques, including but not limited to microwave, infrared or other transmission techniques. The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave; or other transmission technologies. It is contemplated that such a computer program product may be distributed as a removable media with accompanying printed or electronic documentation, e.g., shrink wrapped software, preloaded with a computer system, e.g., on system ROM or fixed disk, or distributed from a server or electronic bulletin board over a network, e.g., the Internet or World Wide Web.

Although various exemplary embodiments of the invention have been disclosed, it will be apparent to those skilled in the art that various changes and modifications can be made which will achieve some of the advantages of the invention without departing from the spirit and scope of the invention. Further, many of the system components described herein have been described using products from International Business Machines Corporation, Armonk, N.Y. It will be obvious to those reasonably skilled in the art that other components performing the same functions may be suitably substituted. Further, the methods of the invention may be achieved in either all software implementations, using the appropriate processor instructions, or in hybrid implementations, which utilize a combination of hardware logic and software logic to achieve the same results. Such modifications to the inventive concept are intended to be covered by the appended claims.

What is claimed is:

1. In a computer system capable of executing a process for sending messages to a recipient address associated with the message and for executing a spell checking process for analyzing character strings within the message, a method comprising:
(A) parsing an address field associated with the message;
(B) storing in memory a character string located within the address field; and
(C) comparing a second character string from the message with at least a portion of the character string stored in memory.

2. The method of claim 1 further comprising:
(D) ignoring the second character string, if the second character string matches at least a portion of the character string stored in memory.

3. The method of claim 1 wherein the address field comprises any of a primary recipient address field, carbon copy recipient address field, blind carbon copy recipient address field, or sender address field.

4. The method of claim 1 wherein the message comprises one of an electronic mail message and an instant message.

5. The method of claim 2 wherein (A) comprises:
(A1) if a character string was found in the address field, extracting substrings from the found character string in accordance with a parser rule.

6. The method of claim 5 wherein (B) comprises:
(B1) storing in memory the substrings extracted from the found character string.

7. The method of claim 6 wherein (C) comprises:
(C1) comparing the second character string from the message with at least one extracted substring stored in memory.

8. The method of claim 1 wherein the address field comprises any of a primary recipient address field, carbon copy recipient address field, blind carbon copy recipient address field or sender address field and wherein (A) comprises:
(A1) extracting character strings found in any of the primary recipient address field, carbon copy recipient address field, blind carbon copy recipient address field and sender address field in accordance with a parser rule.

9. The method of claim 8 wherein (B) comprises:
(B1) concatenating the extracted character strings into a composite character string and storing the composite character string in memory.

10. The method of claim 9 wherein (C) comprises:
(C1) comparing the second character string from the message with the composite character string stored in memory.

11. A computer program product for use with a computer system capable of executing a communication process for sending messages to a recipient address associated with the message and for executing a spell checking process for analyzing character strings within the message, the computer program product comprising a computer useable medium having embodied therein program code comprising:
(A) program code for parsing an address field associated with the message;
(B) program code for storing in memory a character string located within the address field; and
(C) program code for comparing a second character string from the message with at least a portion of the character string stored in memory.

12. The computer program product of claim 11 further comprising:
(D) program code for ignoring the second character string from the message, if the second character string matches at least a portion of the character string stored in memory.

13. The computer program product of claim 11 wherein the address field comprises any of a primary recipient address field, carbon copy recipient address field, bind carbon copy recipient address field or sender address field.

14. The computer program product of claim 11 wherein the message comprises one of an electronic mail message and an instant message.

15. The computer program product claim 11 wherein (A) comprises:
(A1) program code for extracting substrings from the found character string in accordance with a parser rule, if a character string was found in the address field.

16. The computer program product of claim 15 wherein (B) comprises:
(B1) program code for storing in memory the substrings extracted from the found character string.

17. The computer program product of claim 16 wherein (C) comprises:
(C1) program code for comparing a second character string from the message with at least one extracted substring stored in memory.

18. The computer program product of claim 11 wherein the recipient address field comprises any of a primary recipient address field, carbon copy recipient address field or blind carbon copy recipient address field and wherein (A) comprises:
(A1) program code for extracting character string found in any of the primary recipient address field, carbon copy recipient address field, blind carbon copy recipient address field, or sender address field accordance with a parser rule.

19. The computer program product of claim 18 wherein (B) comprises:
(B1) program code for concatenating the extracted character strings into a composite character string and storing the composite character string in memory.

20. The computer program product of claim 19 wherein (C) comprises:
(C1) program code for comparing a second character string from the message with the composite character string stored in memory.

21. A computer data signal embodied in a carrier wave for use with a computer system capable of executing a process for sending messages to an address associated with the message and for executing a spell checking process for analyzing character strings within the message, the computer data signal comprising:
(A) program code for parsing a address field associated with the message;
(B) program code for storing in memory a character string located within the address field; and
(C) program code for comparing a second character string from the message with at least a portion of the character string stored in memory.

22. An apparatus for use with a computer system capable of executing a process for sending messages to an address associated with the message and for executing a spell checking process for analyzing character strings within the message, the apparatus comprising:
(A) program logic for parsing a address field associated with the message;
(B) program logic for storing in memory a character string located within the address field; and
(C) program logic for comparing a second character string from the message with at least a portion of the character string stored in memory.

23. In a computer system capable of executing a communication process for sending messages to a address associated with the message and for executing a spell checking process for analyzing character strings within the message, a method comprising:
(A) storing in a buffer memory a character string from a portion of the message other than an address field associated with the message; and
(B) comparing the character string in the buffer memory with at least a portion of a character string in the address field associated with the message.

24. The method of claim 23 further comprising:
(C) ignoring the character string in the buffer memory, if the character string in the buffer memory matches at least a portion of the character string in the address field.

25. The method of claim 23 wherein the address field comprises any of a primary recipient address field, carbon copy recipient address field, blind carbon copy recipient address field, or sender address field.

26. The method of claim 23 wherein the message comprises one of an electronic mail message and an instant message.

27. A computer program product for use with a computer system capable of executing a communication process for sending messages to a recipient address associated with the message and for executing, a spell checking process for analyzing character strings within the message, the computer program product comprising a computer useable medium having embodied therein program code comprising:
(A) program code for storing in a buffer memory a character string from a portion of the message other than a recipient address field associated with the message; and
(B) program code for comparing the character string in the buffer memory a with at least a portion of a character string in the recipient address field associated with the message.

28. The computer program product of claim 27 further comprising:
(C) program code for ignoring the character string in the buffer memory, if the character string in the buffer memory matches at least a portion of the character string in the address field.

29. The computer program product of claim 27 wherein the address field comprises any of a primary recipient address field, carbon copy recipient address field, blind carbon copy recipient address field, or sender address field.

30. The computer program product of claim 27 wherein the message comprises one of an electronic mail message and an instant message.
